(19) United States
(12) Patent Application Publication
(10) Pub. No.: US 2016/0053152 A1
(43) Pub. Date: Feb. 25, 2016

(54) ANTI-FOG CONSUMER PRODUCTS AND PROCESSES FOR MAKING SAME

(71) Applicant: Celanese Acetate LLC, Irving, TX (US)

(72) Inventors: Kevin Parker, Hilton Derby (GB); Joanna Marshall, Lichfield Staffs (GB); Naresh Budhavaram, Florence, KY (US); Bing Lu, Union, KY (US); Nagarjuna Palyam, Florence, KY (US); Marilyn Collins, Walton, KY (US); Michael Combs, Pembroke, VA (US); Christopher McGrady, Pembroke, VA (US)

(21) Appl. No.: 14/826,374

(22) Filed: Aug. 14, 2015

Related U.S. Application Data
(60) Provisional application No. 62/038,884, filed on Aug. 19, 2014.

(51) Int. Cl. C09K 3/18; C08J 7/12

(52) U.S. Cl. CPC C09K 3/18; C08J 7/12; C08J 2301/12

(57) ABSTRACT

A process for producing an anti-fog consumer product. The process comprises the steps of forming a precursor composition comprising cellulose acetate and plasticizer to yield a substantially rigid consumer product having an outer surface; and saponifying at least a portion of the substantially rigid consumer product to yield the anti-fog consumer product having a degree of substitution at the outer surface of less than 0.75.

### CROSS REFERENCE TO RELATED APPLICATION

This application claims priority to U.S. Provisional Application No. 62/038,884, filed on Aug. 19, 2014, the entirety of which is incorporated by reference herein.

### FIELD OF THE INVENTION

The invention relates generally to anti-fog consumer products and processes for making anti-fog consumer products. In particular, the invention relates to anti-fog consumer products that are formed via a process that involves molding followed by saponification.

### BACKGROUND OF THE INVENTION

Film treatments and compositions are often utilized with many substrates to impart beneficial characteristics and/or properties to the substrate. The surface of an injection molded product, for example, may be coated with a coating composition after formation in order to form a fog resistant layer on its surface. As another example, a fog resistant film may be applied to glass or mirrored surfaces to inhibit fogging thereof.

Traditional coating compositions, however, form a discrete layer adhered to an underlying surface or substrate. It has been observer that with time, the layer will wash or wear away from the substrate resulting in a significant reduction in or a complete elimination of fog resistance. Also, many conventional fog resistant films comprise multiple laminated layers, e.g., a polycarbonate or polyester layer with polyurethane or silane coating, which may separate from one another, creating performance and/or durability problems. This problem of layer separation is often exacerbated when the substrate is curved or shaped. Additionally, the application of traditional coating compositions to curved surfaces has been known to increase haziness in the final product.

Japanese Patent Application No. 2013099879A and International Publication No. 2008/029801A1, both of which are incorporated herein by reference in their entireties, disclose thin fog resistant films and methods for preparing same. The thin fog resistant films may be formed by treating a thin cellulose acetate film with an alkali solution. These fog resistant films may comprise a cellulose ester portion and a fog resistant region. These thin fog resistant films, however, may suffer from insufficient fog resistance and/or a lack of film transparency, e.g., haziness and may be difficult to apply to highly shaped consumer products. Also, these thin films are not suitable for use in applications where a higher degree of rigidity is required, e.g., protective lenses or automotive lamp covers. Nor are these thin films suitable for applications wherein the consumer product must be shaped, e.g., not planar.

Also, although some (untreated) cellulose acetate substrates may have a degree of resistance to some chemicals, many substrates have little resistance to a wider variety of chemicals, specifically the chemicals utilized in insect repellants, lotions, and/or sunscreens. Resistance to these types of chemicals is particularly important in applications that involve thicker, rigid substrates, e.g., lenses and automotive head lamp covers. In addition, conventional cellulose acetate substrates are known to have scratch resistance and surface roughness problems.

The need exists for (shaped) anti-fog consumer products having improved anti-fogging characteristics and/or improved clarity, e.g., reduced haziness, as well as improved chemical resistance, scratch resistance, and surface roughness.

### SUMMARY OF THE INVENTION

In one embodiment, the invention relates to a process for producing an anti-fog consumer product. The process comprises the step of forming a precursor composition comprising cellulose acetate and plasticizer to yield a substantially rigid consumer product having an outer surface and comprising cellulose acetate and plasticizer. The process further comprises the step of saponifying at least a portion of the substantially rigid consumer product to yield an anti-fog consumer product, which has a degree of substitution at the outer surface of less than 0.75. The saponifying may comprise contacting at least a portion of the substantially rigid consumer product with a caustic solution, preferably comprising an aqueous hydroxide solution, more preferably comprising from 5 to 30 wt % potassium hydroxide solution. The contacting may be conducted for a residence time ranging from 0.5 minutes to 50 minutes and or at a temperature ranging from 30° C. to 100° C. In one embodiment, the process further comprises the steps of hard coating the anti-fog consumer product to form a coated anti-fog consumer product; mirror coating the coated anti-fog consumer product to form a mirror coated consumer product and/or coloring the anti-fog consumer product to yield a colored anti-fog consumer product, e.g., dip dying the anti-fog consumer product. The anti-fog consumer product comprises cellulose acetate, e.g., from 40 wt % to 99 wt %, and a plasticizer, e.g., from 1 wt % to 60 wt %, and has an outer surface and a degree of substitution at the outer surface of less than 0.75. The plasticizer may be selected from the group consisting of 1,2,3-triacetoxypropane (triacetin), tributyl citrate, triethyl citrate, triphenyl phosphate, tris(clorisopropyl)phosphate, dimethyl phthalate, bornan-2-one, PEG-DGE, PPG-DGE, tributyl phosphate, and combinations thereof, preferably being diethyl phthalate. The anti-fog consumer product may optionally comprise a coloring agent, preferably a dye or pigment. The anti-fog consumer product has opposing outer surfaces and a central region therebetween. In one embodiment, the degree of substitution from each outer surface of the anti-fog consumer product increases inwardly from the respective outer surface. In one embodiment, the degree of substitution at the central region is from 2.0 to 2.7. The outer surface(s) and the central region may, in one embodiment, be planar and the degree of substitution from each planar outer surface may increase inwardly from the respective planar outer surface. In other embodiments, the outer surface(s) are shaped. In one embodiment, the degree of substitution throughout the treated central region is substantially uniform, preferably varying by less than 10%. The anti-fog consumer product may have: a fog time greater than 20 seconds, a haze value from 0.1% to 4.0%, as measured by ASTM D1003, an impact strength (Charpy impact strength (notched)) ranging from 20 kj/m² to 60 kj/m², as measured by ISO 178, a water vapor transmission rate greater than 100, a scratch resistance less than 0.025 grams lost after 2000 abrasion cycles, as measured in accordance with ASTM D4060, a surface roughness less than 5 microns, and/or a chemical resistance rating less than 3, as measured in accordance with Ford Laboratory Test Method BI 113-08. The anti-fog consumer product may not comprise discrete layers and/or may be substantially free of anti-blocking agent, and preferably substantially free of silica. In one embodiment, the substantially rigid consumer product has a thickness greater than 50 microns. In some embodiments, the precursor composition further comprises a coloring agent, preferably a dye or pigment, and the saponifying may yield a colored anti-fog consumer product.

### DETAILED DESCRIPTION OF THE INVENTION

A new technique has been discovered for improving the anti-fogging characteristics of molded, rigid consumer products. The process involves saponifying the formed, rigid product to yield an anti-fog consumer products having superior anti-fogging characteristics, preferably having a degree of substitution (at an outer surface thereof) less than 0.75, which results in improved anti-fogging characteristics, clarity, and/or thickness. The consumer products thus formed beneficially are able to be utilized in applications requiring a high degree of structural thickness and/or rigidity, e.g., (protective) goggles, visors, masks, or wind screens.

### Processes for Producing Anti-Fog Consumer Products

In the processes of the invention, anti-fog consumer products are prepared by saponifying one or more surfaces of a rigid cellulose acetate consumer product to reduce the degree of substitution thereof to less than 0.75. In a preferred embodiment, a precursor composition comprising cellulose acetate and plasticizer is prepared, preferably by combining cellulose acetate and the plasticizer. The precursor composition may further comprise additional components, as discussed herein. The precursor composition is preferably molded, e.g., injection molded into a mold and cooled, to form a consumer product that is substantially rigid. The substantially rigid consumer product has at least one outer surface, e.g., at least one shaped outer surface. The substantially rigid consumer product preferably is not formed via traditional casting methods, well known in the art. Traditional casting methods, as previously discussed, yield thin films, e.g., films that are not substantially rigid, and are incapable of forming thicker and/or shaped substrates, as are formed by the present process. Thin films are significantly different from rigid, thicker, and/or shaped substrates, and the prior art teachings relating to thin film formation methods are not applicable to methods relating to rigid, thicker, and/or shaped substrates, e.g., molded or formed substrates. In some embodiments, the substantially rigid consumer products of the present invention have performance characteristics that are not applicable to thin films. For example, scratch resistance and surface roughness are characteristics that are typically only applicable to (and measurable in) thicker, substantially rigid consumer products. Scratching and surface abrasion (and the testing relating thereto) would result in destruction of thin films. Improvement of these exemplary characteristics in the thin film arena has not been investigated.

In the saponification process, the substantially rigid consumer product is preferably treated with a caustic solution, e.g., an aqueous hydroxide solution such as a sodium or potassium hydroxide solution, under conditions effective to form the anti-fog consumer product. As a result, the anti-fog consumer product has a degree of substitution at the outer surface of less than 0.75, e.g., less than 0.7, less than 0.6, less than 0.5, less than 0.4, less than 0.3, less than 0.2, or less than 0.1. Without being bound by theory, the anti-fog consumer products formed through the processes of the invention may advantageously permit some moisture to seep into or absorb into the anti-fog consumer product (as opposed to allowing the water to pool atop the film), resulting in improved anti-fogging characteristics.

Without being bound by theory, treatment of the substantially rigid consumer product in the manner described herein modifies, e.g., reduces, the degree of acetyl substitution of the cellulose acetate thereby increasing its anti-fog characteristics. When the caustic treatment is utilized to treat the substantially rigid consumer product formed from the components discussed herein, a unique anti-fog composition having a highly desirable combination of performance characteristics is formed. Modifying, e.g., reducing, the degree of substitution of the substantially rigid consumer product in this manner provides for increased hydrophilicity of the resultant consumer product, e.g., at or in a region near the outer surface or, if treated for a longer duration, throughout the entire thickness of the anti-fog consumer product, allowing for increased water absorption and improved anti-fogging characteristics. Depending on the caustic treatment conditions, e.g., thickness of the substantially rigid consumer product and/or caustic treating time, the degree of substitution of the resulting anti-fog consumer product may be substantially constant throughout the consumer product or may increase from the outer surface toward a center region of the film.

The substantially rigid consumer product may be treated with the caustic solution treatment for a predetermined period of time, e.g., a residence time. In one embodiment, the contacting is conducted for a residence time ranging from 0.5 minutes to 50 minutes, e.g., from 2 minutes to 40 minutes, or from 5 minutes to 30 minutes. In terms of lower limits, the caustic solution treatment may be performed for at least 0.5 minutes, e.g., at least 1 minute, at least 2 minutes, at least 5 minutes, at least 7 minutes, at least 10 minutes, at least 12 minutes, at least 15 minutes, at least 17 minutes, or at least 20 minutes. In terms of upper limits, the caustic solution treatment may be performed for less than 50 minutes, e.g., less than 40 minutes, less than 30 minutes, less than 20 minutes, or less than 10 minutes. The thickness of the substantially rigid consumer product may be a factor in the duration of the caustic solution treatment and the resulting characteristics of the anti-fog compositions.

In one embodiment, the caustic solution treatment step is conducted at a temperature ranging from 30° C. to 100° C., e.g., from 40° C. to 90° C., or 50° C. to 80° C. Generally speaking, hotter treatment temperatures may result in faster saponification. In terms of lower limits, the caustic solution treatment step may be conducted at a temperature greater than 30° C., e.g., greater than 40° C., greater than 50° C., or greater than 65° C. In terms of upper limits, the caustic solution treatment step may be conducted at a temperature less than 100° C., e.g., less than 75° C., or less than 70° C.

In some embodiments, the anti-fog consumer product may be further treated to impart additional desirable characteristics. As one example, the anti-fog consumer product may be further coated. For example, the anti-fog consumer product may be hard coated to form a coated anti-fog consumer product. The coated anti-fog consumer product may then be mirror coated through a sputter coating process to form a mirror coated consumer product. The resultant consumer product has a mirror coated effect on a surface thereof. This process is particularly well suited in forming, for example, sunglasses and goggles.

In some embodiments, a colored anti-fog consumer product may be desired. The anti-fog consumer product may be colored to yield a colored anti-fog consumer product. Many coloring techniques are known in the art, including dip dying and addition of coloring agent, e.g., dye or pigment. In one embodiment, the anti-fog consumer product is dip dyed to yield a colored anti-fog consumer product. In one embodiment, the precursor composition further comprises a coloring agent, preferably a dye or a pigment. As a result of the addition of the coloring agent, step (b) yields the colored anti-fog consumer product.

### Anti-Fog Consumer Product

The present invention also relates to the anti-fog consumer products prepared by the processes of the invention. The anti-fog consumer products comprise cellulose acetate and plasticizer. As noted above, the anti-fog consumer products have at least one outer surface with a degree of substitution less than 0.75. The saponification process may also result in a decrease in degree of substitution in a treated portion underneath the at least one outer surface. As a result, in some embodiments for example, the cellulose acetate in the anti-fog consumer product has a degree of substitution that increases from the outer surface(s) moving inwardly, e.g., into the treated portion. That is, the anti-fog composition may have a “decreasing degree of substitution gradient,” e.g., a degree of substitution that is less at the outer surface(s) of the anti-fog consumer product and increases inwardly. In at least some of these instances, the anti-fog consumer product may be considered to be partially saponified and the anti-fog consumer product may not have a uniform degree of substitution throughout. In some preferred cases, the anti-fog consumer product comprises a saponified portion and a non-saponified portion. Without being bound by theory, it is believed that saponification may have a detrimental effect on structural strength of the substrate being saponified. Thus, in some embodiments, the non-saponified portion of the anti-fog consumer product advantageously provides structural benefits, while the saponified portion provides anti-fog benefits.

The outer surface of the anti-fog consumer product may vary widely, but in some exemplary embodiments is planar. In other embodiments, the outer surface of the anti-fog consumer product is shaped. As used herein, the term shaped means non-planar, optionally arcuate or curved. In one embodiment, the anti-fog consumer product has opposing (substantially) planar outer surfaces and a (substantially) planar central region. In one embodiment, the anti-fog consumer product has opposing shaped outer surfaces and a shaped central region is disposed between the opposing shaped outer surfaces. In preferred embodiments, the shape and/or contour of the central region substantially matches or conforms with the shape and/or contour of the outer surfaces. The degree of substitution from each outer surface may increase inwardly from the respective outer surface.

The anti-fog consumer product may have a middle, which is disposed between the opposing shaped outer surfaces and is substantially equidistant from two opposing outer surfaces. The middle is in the central region.

As indicated above, the anti-fog consumer product of the invention preferably has a degree of substitution at one or more outer surfaces less than 0.75, e.g., less than 0.7, less than 0.6, less than 0.5, less than 0.4, less than 0.3, less than 0.2, or less than 0.1. In terms of lower limits, the degree of substitution at one or more outer surfaces may be at least 0.05, e.g., at least 0.1, at least 0.2, at least 0.3, or at least 0.5. In one embodiment, the degree of substitution at one or more of the outer surfaces is substantially zero, e.g., from 0 to 0.5 or from 0 to 0.25. In terms of ranges, the degree of substitution at one or more of the outer surfaces may range from 0 to 0.75, e.g., from 0 to 0.7, from 0.1 to 0.6, from 0.2 to 0.5, or from 0.3 to 0.5. In some embodiments, if the anti-fog consumer product is (substantially) planar, these ranges and limits are applicable to (substantially) planar outer surface(s). In some embodiments, if the anti-fog consumer product is shaped, these ranges and limits are applicable to shaped outer surface(s).

In some embodiments, the degree of substitution in the central region of the anti-fog consumer product, ranges from 2.0 to 2.7, e.g., from 2.0 to 2.6, from 2.0 to 2.55, from 2.1 to 2.55, from 2.2 to 2.55, or from 2.3 to 2.55. In terms of upper limits, the degree of substitution in the central region may be less than 2.6, e.g., less than 2.55, less than 2.5, less than 2.4, less than 2.3, or less than 2.2, but preferably at least 2.0, e.g., at least 2.1, or at least 2.3. In some embodiments, if the anti-fog consumer product is (substantially) planar, these ranges and limits are applicable to a (substantially) planar central region between two (substantially) planar outer surfaces. In some embodiments, if the anti-fog consumer product is shaped, these ranges and limits are applicable to a shaped central region between two shaped outer surfaces. The ranges and limits are also applicable to the middle of the anti-fog consumer product. The degree of substitution of the anti-fog consumer product affects its hydrophilicity and its anti-fog characteristics, with lower degrees of substitution generally corresponding to increased hydrophilicity. The increased hydrophilicity in turn allows for increased water absorption in the anti-fog consumer product, which beneficially provides for a longer lasting anti-fogging effect.

As noted above, the geometry of the outer surface(s) of the consumer product may vary widely, but in some embodiments is shaped or planar.

In some embodiments, the anti-fog consumer product has opposing shaped outer surfaces and a central region and the degree of substitution may be substantially uniform throughout its entire thickness. In some embodiments, the anti-fog consumer product has opposing (substantially) planar outer surfaces and a (substantially) planar central region and the degree of substitution may be substantially uniform throughout its entire thickness.

In some of these cases the degree of substitution throughout the anti-fog consumer product may vary by less than 10%, e.g., less than 7.5%, less than 5%, less than 2.5%, or less than 1%. That is, the anti-fog composition may have a “uniform degree of substitution gradient.” In some of these instances, the anti-fog consumer product may be considered to be fully saponified. The actual degree of substitution over the center region may optionally vary by no more than 0.75, by no more than 0.5, or by no more than 0.25, throughout the treated portion. In some embodiments, the cellulose acetate in the center region of the anti-fog consumer product has a degree of substitution less than 0.75, e.g., less than 0.7, less than 0.6, less than 0.5, less than 0.4, less than 0.3, less than 0.2, or less than 0.1. In terms of lower limits, the degree of substitution in the center region may be at least 0.05, e.g., at least 0.1, at least 0.2, at least 0.3, or at least 0.5. In one embodiment, the degree of substitution in the central region is substantially zero, e.g., from 0 to 0.5 or from 0 to 0.25. In terms of ranges, the degree of substitution in the central region may range from 0 to 0.75, e.g., from 0 to 0.7, from 0.1 to 0.6, from 0.2 to 0.5, or from 0.3 to 0.5.

The anti-fog consumer product, in some embodiments, does not comprise discrete layers, unlike some anti-fog consumer products that utilize a multi-layer construction comprising a base layer, e.g., a cellulose acetate layer, a polycarbonate layer, or a polyethylene terephthalate layer, and an anti-fog layer. As such, the present anti-fog compositions beneficially may avoid the problems associated with adherence of an anti-fog layer to a base layer, e.g., eventual separation of the layers during use.

As noted above, the substantially rigid consumer product is formed from the precursor composition. The forming is contemplated broadly and includes molding, extruding, injection molding, vacuum forming, and thermoforming, as long as a substantially rigid consumer product is formed. Thick film formation processes are also contemplated, as long as a thick, substantially rigid consumer product is formed thereby. This listing is merely exemplary and is not meant to be limiting. Conventional thin film formation processes utilize casting processes to form the pre-treated thin films, i.e., films that are neither substantially rigid nor shaped. Such thin films are often subject to blocking when wrapped in roll form or when stacked. As such, anti-blocking agents, e.g., silica, must be employed to avoid such blocking Advantageously, because the processes of the present invention utilize a molding process, the use of anti-blocking agents is not required. Thus, in some embodiments, the anti-fog consumer product is substantially free of anti-blocking agents such as silica.

The anti-fog consumer product, in one embodiment, comprises from 40 wt % to 99 wt % cellulose acetate, e.g., from 50 wt % to 90 wt %, from 60 wt % to 80 wt %, or from 65 wt % to 75 wt %. In terms of lower limits, the anti-fog consumer product may comprise at least 40 wt % cellulose acetate, e.g., at least 50 wt %, at least 60 wt % or at least 65 wt %. In terms of upper limits, the anti-fog consumer product may comprise less than 99 wt % cellulose acetate, e.g., less than 90 wt %, less than 80 wt % or less than 75 wt %. The precursor compositions and the substantially rigid consumer products may comprise similar amounts of cellulose acetate.

The anti-fog consumer product, in one embodiment, comprises from 1 wt % to 60 wt % plasticizer, e.g., from 10 wt % to 50 wt %, from 20 wt % to 40 wt %, or from 25 wt % to 35 wt %. In terms of lower limits, the anti-fog composition may comprise at least 1 wt % plasticizer, e.g., at least 10 wt %, at least 20 wt % or at least 25 wt %. In terms of upper limits, the anti-fog composition may comprise less than 60 wt % plasticizer, e.g., less than 50 wt %, less than 40 wt %, or less than 35 wt %. The precursor compositions and the substantially rigid consumer products may comprise similar amounts of plasticizer. Additional details of the components of the above-mentioned components are provided herein.

As noted above, in some embodiments, the anti-fog consumer products are significantly thicker than cellulose acetate-based film compositions. For example, the anti-fog consumer products may have a thickness (minimum dimension of the consumer product) greater than 50 microns, e.g., greater than 100 microns, greater than 500 microns, greater than 750 microns, greater than 1000 microns, greater than 2000 microns, or greater than 5000 microns. Thicknesses may be measured via the methods known in the art, e.g., microscope, infrared scanning. The maximum thickness is largely dependent on the size of the container used in the saponification step and may vary widely. In some preferred aspects, the consumer product has a thickness less than 1 meter, e.g., less than 25 cm, less than 15 cm, less than 5 cm, less than 5000 microns, or less than 1000 microns. In terms of ranges, the thickness may be, for example, from 100 microns to 1 meter, e.g., from 100 microns to 1 cm, from 100 microns to 5000 microns, or from 500 to 5000 microns.

In some embodiments, particular anti-fog consumer products have unique combinations of components, which result in desired performance characteristics. As indicated, the precursor composition and the consumer products formed therefrom comprise cellulose acetate and a plasticizer. For example, the plasticizer may comprise a phthalate plasticizer such as diethyl phthalate. In some cases, combinations of these specific components result in anti-fog compositions having the desirable characteristics discussed herein.

### Performance Characteristics

The anti-fog consumer product, in some embodiments, has a fog time greater than 10 seconds, e.g., greater than 20 seconds, greater than 30 seconds, greater than 40 seconds, greater than 50 seconds, greater than 60 seconds, or greater than 70 seconds. In terms of ranges, the anti-fog composition may have a fog time ranging from 10 seconds to 150, e.g., from 20 seconds to 100 seconds or from 30 seconds to 90 seconds. In one embodiment, the fog time may be determined by placing an anti-fog film of the invention over a beaker of heated water, e.g., heated to approximately 50° C., and measuring the time taken for a fog to form, if any. The sample may be placed at a predetermined distance from the film, e.g., approximately 6 cm. In other cases, test methods EN166 and/or EN168.16 (2014 or 2015) may be utilized.

The anti-fog consumer product, in some embodiments, has a haze value, e.g., an ASTM D1003 (2014 or 2015) haze value, less than 4%, e.g., less than 3%, less than 2.5%, less than 2%, less than 1.5%, less than 1.2%, or less than 1%. In terms of ranges, the anti-fog composition may have a haze value ranging from 0.1% to 4%, e.g., from 0.1% to 3.5%, from 0.5% to 4%, from 0.1% to 3%, 0.1% to 2%, from 0.2% to 3%, from 0.3% to 2.5%, or from 0.6% to 1%. In one embodiment, the haze may be measured by hazemeter. In one embodiment, haze may be measured with properly sized specimens having substantially plane-parallel surfaces, e.g., flat without wrinkling, free of dust, scratches, and particles, of about 0.85 mm in thickness using an UtraScan Pro analyzer from Hunter Labs with haze setting of D65/10.

In one embodiment, the anti-fog consumer product has haze Δ ranging from 0% to 10%, e.g., from 0% to 5%, from 0% to 1%, or from 0% to 0.1%. Haze Δ may be determined by measuring haze of the anti-fog consumer product before and after rubbing with a microfiber cloth under 1 pound of weight. The change in the haze measurements before and after the rubbing is the haze Δ. In terms of lower limits, the anti-fog consumer product may have a haze Δ less than 10%, e.g., less than 5%, less than 1% or less than 0.1%.

In one embodiment, the anti-fog consumer product has a moisture (water) vapor transmission rate (MVTR) ranging from 5 g/m²/day to 1000 g/m²/day (at 25° C. and 75% relative humidity), e.g., from 100 g/m²/day to 1000 g/m²/day, from 200 g/m²/day to 1000 g/m²/day or from 250 g/m²/day to 750 g/m²/day. In terms of lower limits, the anti-fog composition may have a water vapor transmission rate greater than 100 g/m²/day, e.g., greater than 200 g/m²/day, or greater than 250 g/m²/day. In terms of upper limits, the anti-fog composition may have a water vapor transmission rate less than 1000 g/m²/day, e.g., less than 900 g/m²/day, or less than 750 g/m²/day. Water vapor transmission rate may be measured by gravimetric techniques. In one embodiment, the water vapor transmission rate is measured as noted in one of the following ASTM test standards (2014 or 2015) ASTM F1249-06, ASTM E398-03, ASTM D1434, ASTM D3079, ASTM D4279, ASTM E96, ASTM E398, ASTM F1249, ASTM F2298, or ASTM F2622. In some cases, the MVTE will be dependent upon the thickness of the consumer product.

In one embodiment, the anti-fog consumer product has an impact strength (Charpy impact strength (notched)) ranging from 20 kj/m² to 60 kj/m², as measured by ISO 178, e.g., from 30 kj/m² to 50 kj/m². In terms of lower limits, the anti-fog composition may have an impact resistance greater than 20 kj/m², e.g., greater than 30 kj/m². In terms of upper limits, the anti-fog composition may have an impact resistance less than 60 kj/m², e.g., less than 50 kj/m².

In one embodiment, the anti-fog consumer product has a transparency ranging from 40% to 100%, as measured by ASTM D1746 (2014 or 2015) e.g., from 70% to 90%. In terms of lower limits, the anti-fog composition may have a transparency greater than 40%, e.g., greater than 70%. In terms of upper limits, the anti-fog composition may have a transparency less than 100%, e.g., less than 90%.

In one embodiment, the anti-fog consumer product has a light diffusion ranging from 0.1 cd/m²/lx to 0.26 cd/m²/lx as measured by EN 167 4 (2014 or 2015) e.g., from 0.15 cd/m²/lx to 0.25 cd/m²/lx. In terms of lower limits, the anti-fog composition may have a light diffusion greater than 0.1 cd/m²/lx, e.g., greater than 0.15 cd/m²/lx. In terms of upper limits, the anti-fog composition may have a light diffusion less than 0.26 cd/m²/lx e.g., less than 0.25 cd/m²/lx.

In one embodiment, the anti-fog consumer product has a gloss ranging from 100 to 200 as measured by ASTM D5423 (2014 or 2015) e.g., from 125 to 175, or from 145 to 155. In terms of lower limits, the anti-fog composition may have a light diffusion greater than 100, e.g., greater than 125 or greater than 145. In terms of upper limits, the anti-fog composition may have a light diffusion less than 200 e.g., less than 175 or less than 155.

In one embodiment, the anti-fog consumer product has a tensile strength ranging from 40 Nmm⁻² to 140 Nmm⁻², as measured by ASTM D882 (2014 or 2015), e.g., from 70 Nmm⁻² to 110 Nmm⁻². In terms of lower limits, the anti-fog composition may have a tensile strength greater than 40 Nmm⁻², e.g., greater than 70 Nmm⁻². In terms of upper limits, the anti-fog composition may have a tensile strength less than 140 Nmm⁻², e.g., less than 90 Nmm⁻².

In one embodiment, the anti-fog consumer product has an elongation ranging from 20% to 60%, as measured by ASTM D882 (2014 or 2015), e.g., from 25% to 55%. In terms of lower limits, the anti-fog composition may have an elongation greater than 20%, e.g., greater than 25%. In terms of upper limits, the anti-fog composition may have an elongation less than 60%, e.g., less than 55%.

The anti-fog consumer product, in some embodiments, has a scratch resistance less than 0.025 grams of weight loss after a set number of abrasion cycles, e.g., less than 0.020, less than 0.012, less than 0.010, less than 0.008, less than 0.006, less than 0.004, or less than 0.003. In terms of ranges, the anti-fog consumer product may have a scratch resistance ranging from 0 grams of weight loss to 0.025 grams of weight loss, e.g., from 0.00001 to 0.020, from 0.00001 to 0.010, or from 0.00005 to 0.008. The scratch resistance measurement may be determined via ASTM D4060 (2014 or 2015) and the abrasion cycles may be performed using a Taber reciprocating abraser. For example, 2000, 1500, 1000, 500, or 200 abrasion cycles may be utilized.

In one embodiment, the anti-fog consumer product has a surface roughness less than 5 microns, e.g., less than 4.5 microns, less than 4 microns, less than 3 microns, less than 2.75 microns, or less than 2.7 microns. In terms of ranges, the anti-fog consumer product may have a surface roughness ranging from 0 to 5 microns, e.g., from 0.01 to 4.5 microns, from 0.5 to 4 microns, or from 0.5 to 3 microns. The surface roughness measurement may be determined by using a Mitutoyo Surftest surface roughness gauge, e.g., model SJ-210, SJ-310, or SJ-410.

The anti-fog consumer product, in some embodiments, has improved resistance to chemicals, e.g., chemicals in sunscreens, lotions, and/or insect repellants. In some cases, the anti-fog consumer product has a chemical resistance rating (as measured under Ford Laboratory Test Method BI 113-08 (2008)) less than 3, e.g., less than 2.5, less than 2, or less than 1.5. In terms of ranges, the anti-fog consumer product may have a chemical resistance ranging from 0 to 3, e.g., from 0.01 to 2.5, from 0.01 to 2, or from 0.01 to 1.5 microns. In one embodiment, the anti-fog consumer product show no cloth impression. These chemical resistance ratings are further discussed herein. In one embodiment, the improved chemical resistance is related to N,N diethyl-meta-toluamide (DEET).

The above-mentioned test methods are incorporated by reference herein.

### Main Precursor Components

Cellulose is generally known to be a semi-synthetic polymer containing anhydroglucose repeating units with three hydroxyl groups per anhydroglucose unit. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification. Combinations of sources are also within the contemplation of the invention.

Cellulose esters suitable for use in producing the anti-fog consumer products of the present invention may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof. Cellulose esters suitable for use in producing the anti-fog consumer products of the present invention may, in some embodiments, have a molecular weight ranging from a lower limit of about 10,000, 15,000, 25,000, 50,000, or 85,000 to an upper limit of about 125,000, 100,000, or 85,000, and wherein the molecular weight may range from any lower limit to any upper limit and encompass any subset therebetween. In one embodiment, the number average molecular weight of the cellulose acetate may range from 40,000 amu to 100,000 amu, e.g., from 50,000 amu to 80,000 amu.

The degree of acetylation of cellulose acetate may vary, and any given cellulose acetate composition may be characterized by an acetyl value, which is a measure of the degree of substitution of the cellulose acetate. The acetyl value represents the weight percent of acetic acid liberated by the saponification of cellulose acetate, and is linearly related to the degree of substitution. The degree of substitution may be calculated from the acetyl value according to the following formula:

$$Degree of substitution = \frac{Acetyl value \times 162}{6005 - ( Acetyl value \times 42 )}$$

The cellulose acetate used in the production of the anti-fog consumer products may be cellulose diacetate or cellulose triacetate, and hence may have an average degree of substitution from 2 and 3, e.g., from 2.2 to 2.8 or from 2.4 to 2.65.

The cellulose acetate may be utilized in powder or flake form, preferably flake form. In some embodiments, the cellulose acetate, in powder or flake form, may be formulated and injection molded into pellets that may be molded into the substantially rigid consumer product.

The flake form of cellulose acetate, if utilized, may have an average flake size from 5 μm to 10 mm, as determined by sieve analysis. The flake preferably has low moisture content, optionally comprising less than 6 wt % water, e.g., less than 5 wt % water or less than 2.5 wt % water. In terms of ranges, the flake form may have from 0.01 to 6 wt % water, e.g., from 0.1 to 2.5 wt % water or from 0.5 to 2.45 wt % water. Prior to mixing, the cellulose acetate flake may be heated to remove moisture. In some embodiments, the cellulose acetate flake may be dried until it has a water content of less than 2 wt. %, e.g., less than 1.5 wt. %, less than 1 wt. % or less than 0.2 wt. %, The drying may be conducted at a temperature from 30 to 100° C., e.g., from 50 to 80° C. and for a period of 1 to 24 hours, e.g., from 5 to 20 hours or from 10 to 15 hours.

The plasticizer may vary widely. Suitable plasticizers may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, propylene carbonate, C₁-C₂₀ diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof. In some embodiments, plasticizers may be food-grade plasticizers. Examples of food-grade plasticizers may include, but are not limited to, triacetin, trimethyl citrate, triethyl citrate, tributyl citrate, eugenol, cinnamyl alcohol, methoxy hydroxy acetophenone (acetovanillone), vanillin, ethylvanillin, polyethylene glycols, and the like, and any combination thereof.

In one embodiment, the plasticizer is selected from the group consisting of 1,2,3-triacetoxypropane (triacetin), tributyl citrate, diethyl phthalate, triethyl citrate, triphenyl phosphate, tris(clorisopropyl)phosphate, dimethyl phthalate, bornan-2-one, PEG-DGE, PPG-DGE, tributyl phosphate, and combinations thereof. In one embodiment the plasticizer comprises a phthalate plasticizer. In preferred embodiments, the plasticizer comprises diethyl phthalate. In some embodiments, the anti-fog composition comprises diethyl phthalate and silica having an average particle size ranging from 0.02 microns to 6 microns. In one embodiment, the plasticizer does not comprise triacetin.

### Optional Additives

In some embodiments, the anti-fog consumer product, and the precursors or substantially rigid consumer products preferably used to form the anti-fog consumer products, may further comprise one or more additional additives, e.g., tackifiers, flame retardants, antioxidants, antibacterial agents, antifungal agents, colorants, pigments, dyes, UV-stabilizers, viscosity modifiers, processing additives, and the like, and any combination thereof. The amount of the additives may vary widely. Generally speaking the one or more additives may be present in an amount ranging from 0.01 to 10 wt. %, based on the total weight of the anti-fog consumer products, e.g., from 0.03 to 2 wt. %, or from 0.1 to 1 wt. %.

In one embodiment, UV absorber additives may be included in the anti-fog consumer products. For example, the anti-fog consumer products (with a UV absorber additive) may be utilized in a situation where UV light may damage the contents enclosed by the anti-fog consumer products. One example may be a refrigerator or freezer in which the anti-fog consumer products (with a UV absorber additive) are utilized to protect meat or fish from potentially damaging UV light. As another example, UV absorber additives may be added to provide UV protection for the eyes, e.g., in goggle applications.

Colorants, pigments, and dyes suitable for use in conjunction with the anti-fog consumer products described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, nickel titanate, benzimidazolone orange gl, solvent orange 60, orange dyes, calcium carbonate, kaolin clay, aluminum hydroxide, barium sulfate, zinc oxide, aluminum oxide, CARTASOL™ dyes (cationic dyes, available from Clariant Services) in liquid and/or granular form (e.g., CARTASOL Brilliant Yellow K-6G liquid, CARTASOL Yellow K-4GL liquid, CARTASOL Yellow K-GL liquid, CARTASOL Orange K-3GL liquid, CARTASOL Scarlet K-2GL liquid, CARTASOL Red K-3BN liquid, CARTASOL Blue K-5R liquid, CARTASOL Blue K-RL liquid, CARTASOL Turquoise K-RL liquid/granules, CARTASOL Brown K-BL liquid), FASTUSOL™ dyes (an auxochrome, available from BASF), e.g., Yellow 3GL, Fastusol C Blue 74L), and the like, any derivative thereof, and any combination thereof. In one embodiment, solvent dyes may be employed.

In some embodiments, colorants, pigments and dyes suitable for use in conjunction with the anti-fog consumer products described herein may comprise food-grade pigments and/or dyes. Examples of food-grade pigments and dyes may, in some embodiments, include, but are not limited to, plant dyes, vegetable dyes, and the like, and any combination thereof.

### Process for Producing the Anti-Fog Composition

In one embodiment, the invention relates to a process for producing the anti-fog consumer products disclosed herein. The process comprises the step of forming a precursor composition comprising cellulose acetate and plasticizer to form a substantially rigid consumer product. The forming step may include, for example, molding, extruding, injection molding, vacuum forming, and thermoforming, as long as a substantially rigid consumer product is formed. The process further comprises the step of saponifying at least a portion of the substantially rigid consumer product to yield the anti-fog consumer product. In one embodiment, the treatment of the substantially rigid consumer product serves to partially or completely saponify the substantially rigid consumer product, thus creating the desired (uniform or non-uniform) degree of substitution, as discussed herein.

The process may further comprise the steps of washing and drying the anti-fog consumer product. The washing, in some embodiments, inhibits or eliminates the formation of salts on the surface of the anti-fog consumer product. The washing step may be achieved by any suitable technique that washes the surface of the treated film. In one embodiment, the washing is conducted at a temperature ranging from 0° C. to 50° C., e.g., from 20° C. to 40° C. or from 25° C. to 35° C. In terms of lower limits, the washing may be conducted at a temperature greater than 0° C., e.g., greater than 20° C., or greater than 25° C. In terms of upper limits, the washing may be conducted at a temperature less than 50° C., e.g., less than 40° C., or less than 35° C.

The drying may be achieved, for example, under ambient conditions (air drying) or in an oven (oven drying). In one embodiment, the oven drying is conducted at a temperature ranging from 50° C. to 120° C., e.g., from 55° C. to 100° C. or from 60° C. to 80° C. In terms of lower limits, the oven drying may be conducted at a temperature greater than 50° C., e.g., greater than 55° C., or greater than 60° C. In terms of upper limits, the oven drying may be conducted at a temperature less than 120° C., e.g., less than 100° C., or less than 80° C.

The precursor composition may be any composition that comprises cellulose acetate and plasticizer that is used in the molding step to form the substantially rigid consumer product.

In one embodiment, a mixture comprising cellulose acetate, plasticizer, and optional additives, may be melt extruded to form a sheet, or melt extruded in a small hole die to form filaments. The sheet or filaments may then be sent to a pelletizer to form pellets. The sheets, filaments, and/or pellets may then serve as the precursor composition, which is formed, e.g., extrusion molded, to form the substantially rigid consumer product. If the mixture used to form the sheets, filaments, and/or pellets is melt extruded in a film die to form a sheet or is melt extruded in a small hole die to form filaments, then the melt extrusion may be performed at a temperature of up to 230° C., e.g., up to 220° C. or up to 210° C. A temperature greater than 230° C. may lead to destabilization of the mixture components, particularly of the cellulose acetate. The melt extruder may be a twin screw feeder with co-rotating screws, and may be operated at a screw speed from 100 to 500 rpm, e.g., from 150 to 450 rpm, or from 250 to 350 rpm. The sheet may have a thickness between 0.5 and 0.6 mm, e.g., from 0.53 to 0.54 mm. The melt extrusion utilized to form sheets, filaments, and/or pellets is a step that is separate from the forming of the precursor composition to form the substantially rigid consumer product, although the two steps may, in some cases, be utilized in conjunction with one another.

Thus, the “precursor composition” of the present invention may refer to either (a) a mixture of cellulose acetate and plasticizer formed before an initial sheet/filament/pellet-forming extrusion step to form pellets, (b) pellets, also comprising cellulose acetate and plasticizer, formed from the sheet/filament/pellet-forming extrusion step and used in a molding step to form the substantially rigid consumer product, or (c) both.

As noted herein, in one embodiment, the substantially rigid consumer product is formed via molding, e.g., via a melt extrusion process. The process preferably comprises the step of melt extruding a precursor composition, e.g., in the form of pellets comprising cellulose acetate and a plasticizer, to form the substantially rigid consumer product. The pellets may further comprise an antioxidant and/or a heat stabilizer and/or any other suitable additive.

One benefit of employing a precursor composition comprising plasticizer and cellulose acetate is that it preferably results in a composition having a lower melting temperature relative to a similar cellulose acetate-containing composition without plasticizer.

In cases where sheets, filaments, and/or pellets are formed, the mixture used to form the sheets, filaments, and/or pellets may be formed by combining cellulose acetate, in flake or powder form, with plasticizer in a high speed mixer. In some embodiments, the plasticizer may be combined with the cellulose acetate using a spray distribution system during the mixing step. In other embodiments, the plasticizer may be added to the cellulose acetate during the mixing step, either continuously or intermittently. If included in the mixture, the additives may be combined with the cellulose acetate and plasticizer during the mixing step. In some embodiments, a high speed mixer may be operated for 1 to 2 minutes to form the mixture. Optionally, a base mixture may be prepared and the composition of the base mixture may then be adjusted with additional plasticizer and/or additives.

A preferred embodiment utilizes pellets to form the substantially rigid consumer product. The pellets may be heated, e.g., melted, and then employed in the molding process. Thus, the heated pellets serve as the precursor composition to form the anti-fog consumer product. It is also contemplated, however, that a mixture of cellulose acetate and plasticizer may be prepared and employed as the precursor composition, e.g., without first being formed into sheets, filaments, or pellets. In this case, the mixture of cellulose acetate and plasticizer serves as the precursor composition to form the anti-fog consumer product. In one embodiment, the process involves a single melt extrusion step, e.g., no more than one melt extrusion step, in which a mixture comprising cellulose acetate and plasticizer in non-sheet/filament/pellet form is directly melt extruded to form the substantially rigid consumer product, which is then saponified as described herein to render it fogging resistant.

In some embodiments when an extrusion process is utilized to form the substantially rigid consumer product, antioxidants may be used to mitigate oxidation and/or chemical degradation of the anti-fog composition described herein during storage, transportation, and/or implementation. Antioxidants suitable for use in conjunction with the anti-fog composition described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, ubiquinol, gallic acids, melatonin, secondary aromatic amines, benzofuranones, hindered phenols, polyphenols, hindered amines, organophosphorus compounds, thioesters, benzoates, lactones, hydroxylamines, and the like, and any combination thereof. In one embodiment, the antioxidant may be selected from the group consisting of stearyl 3-(3,5-di-tert-butyl-4-hydroxyphenyl) propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide and combinations thereof.

In some embodiments, the precursor composition, the substantially rigid consumer product, and consumer product formed therefrom include food-grade antioxidants. Examples of food-grade antioxidants may include, but are not limited to, ascorbic acid, vitamin A, tocopherols, and the like, and any combination thereof.

In some melt extrusion-related embodiments, the precursor composition, the substantially rigid consumer product, and consumer product formed therefrom include a viscosity modifier. Viscosity modifiers suitable for use in conjunction with the anti-fog consumer products described herein may, in some embodiments, include, but are not limited to, polyethylene glycols, and the like, and any combination thereof, which, in some embodiments, may be a food-grade viscosity modifier.

The saponifying step preferably comprises a caustic treatment step, and may be achieved via a wide variety of methods. An exemplary method is alkali saponification treatment. For example, see International Patent Application No. WO 2008/029801, which is incorporated herein by reference. In one embodiment, the substantially rigid consumer product is submerged in a bath of caustic solution. Caustic treatment alters the degree of substitution of the substantially rigid consumer product, increasing its hydrophilicity, and improving anti-fog characteristics. The caustic treatment step preferably substitutes one or more of the acetyl groups of the cellulose acetate with another substituent, e.g., a hydroxyl group, a carbonyl group, or a carboxylic acid group, until a desired degree of hydrophilicity is obtained.

In another embodiment, the substantially rigid consumer product is bonded to one or more films, of the same or different composition, prior to saponifying. Multiple precursor layers may be formed and then stacked upon one another and ultimately on the substantially rigid consumer product. The stacked precursor film may then be saponified with a caustic solution.

The caustic solution may comprise any suitable alkali solution, many of which are known in the art. The caustic solution, in one embodiment, comprises an aqueous hydroxide solution. The caustic solution may comprise from 5 wt % to 30 wt % alkali solution, e.g., from 5 wt % to 25 wt % or from 7 wt % to 20 wt %. In some embodiments, the caustic solution comprises a potassium hydroxide solution present in the amounts discussed herein. The combination of the specific composition of the substantially rigid consumer product and the caustic treatment advantageously provides for the anti-fog consumer product having the features described herein, e.g., the ability absorb some water and reducing fogging.

The composition of the caustic solution may vary widely. In one embodiment, the molarity of the caustic solution is from 0.1M to 25M, e.g., from 0.1M to 17.5M, from 2M to 10M, or from 2M to 2.5M. In terms of percent concentration, the caustic solution may have a concentration ranging from 5% to 20%, e.g., from 12% to 18% or from 13% to 17%. Various combinations of processing conditions, e.g., residence time, temperature, molarity, and caustic solution composition, are contemplated. The caustic solution may comprise a hydroxide solution, e.g., lithium hydroxide, sodium hydroxide, and/or potassium hydroxide, with potassium hydroxide being preferred. The residence time (in the caustic solution) varies widely. In one embodiment, the residence time ranges from 30 seconds to several hours, e.g., from 1 minute to 1 hour, from 1 minute to 30 minutes, or from 4 minutes to 13 minutes. The temperature of the caustic solution may range from 50° C. to 80° C., e.g., from 55° C. to 75° C., from 60° C. to 70° C., or from 64° C. to 67° C. In one embodiment, the temperature of the caustic solution may be greater than 50° C., e.g., greater than 60° C., greater than 61° C., greater than 62° C., greater than 63° C., greater than 64° C., greater than 65° C., or greater than 66° C. In one embodiment, the temperature of the caustic solution may be less than 70° C., e.g., less than 69° C., less than 68° C., less than 67° C., less than 66° C., less than 65° C., less than 64° C., or less than 63° C. For example, in a preferred embodiment, the caustic solution comprises a 3M potassium hydroxide solution and the treatment is performed at 60° C. for 5 or 10 minutes. In another embodiment, the caustic solution comprises a 2.8M potassium hydroxide solution and the treatment is performed at 72.1° C. for 20 minutes.

In one embodiment, the process comprises the step of contacting the substantially rigid consumer product with acetone prior to saponifying. Without being bound by theory, contacting the cellulose acetate substantially rigid consumer product with acetone may open up the pores of the film, soften the surface of the film, and/or makes the film more porous, which advantageously provides for improved, faster saponification.

The following embodiments are contemplated. All combinations of features and embodiments are contemplated.

### Embodiment 1

An anti-fog consumer product comprising cellulose acetate and a plasticizer and having an outer surface, the anti-fog consumer product comprising cellulose acetate and a plasticizer and having a degree of substitution at the outer surface of less than 0.75.

### Embodiment 2

The embodiment of any one of embodiment 1 and 3-16 wherein the degree of substitution increases from the outer surface moving inwardly.

### Embodiment 3

The embodiment of any one of embodiments 1, 2, and 4-16 further comprising a treated central region disposed beneath the outer surface and wherein the degree of substitution throughout the central region is substantially uniform, preferably varying by less than 10%.

### Embodiment 4

The embodiment of any one of embodiments 1-3 and 5-16 wherein the anti-fog consumer product has a fog time greater than 20 seconds, preferably greater than 30 seconds, more preferably greater than 40 seconds.

### Embodiment 5

The embodiment of any one of embodiments 1-4 and 6-16 wherein the anti-fog consumer product has a haze value ranging from 0.1% to 4.0%, preferably from 0.1% to 2.0%, as measured by ASTM D1003.

### Embodiment 6

The embodiment of any one of embodiments 1-5 and 7-16 wherein the anti-fog consumer product has an impact strength ranging from 20 kj/m² to 60 kj/m², as measured by ISO 178.

### Embodiment 7

The embodiment of any one of embodiments 1-6 and 8-16 wherein the anti-fog consumer product has a water vapor transmission rate greater than 100.

### Embodiment 8

The embodiment of any one of embodiments 1-7 and 9-16 wherein the anti-fog consumer product comprises from 60 wt % to 99 wt % cellulose acetate, and/or from 5 wt % to 65 wt. % plasticizer.

### Embodiment 9

The embodiment of any one of embodiments 1-8 and 10-16 further comprising a coloring agent, preferably being a dye or pigment.

### Embodiment 10

The embodiment of any one of embodiments 1-9, 11, 12 and 14-16 wherein the anti-fog consumer product has opposing outer surfaces and a center planar region and the degree of substitution from each outer surface increases inwardly toward the center plane.

### Embodiment 11

The embodiment of embodiment 10, wherein the degree of substitution at the central planar region from 2.0 to 2.7, preferably from 2.0 to 2.6, more preferably from 2.2 to 2.55.

### Embodiment 12

The embodiment of any one of embodiments 1-11 and 13-16 wherein the outer surface is arcuate or planar.

### Embodiment 13

The embodiment of any one of embodiments 1-9, 12, and 14-16 wherein anti-fog consumer product comprises opposing shaped outer surfaces and wherein a center is disposed therebetween and the degree of substitution from each outer surface increases inwardly toward the center.

### Embodiment 14

The embodiment of any one of embodiments 1-13, 15, and 16 wherein the anti-fog consumer product does not comprise discrete layers.

### Embodiment 15

The embodiment of any one of embodiments 1-14 and 16 wherein the plasticizer is selected from the group consisting of 1,2,3-triacetoxypropane (triacetin), tributyl citrate, triethyl citrate, triphenyl phosphate, tris(clorisopropyl)phosphate, dimethyl phthalate, bornan-2-one, PEG-DGE, PPG-DGE, tributyl phosphate, and combinations thereof, preferably being diethyl phthalate.

### Embodiment 16

The embodiment of any one of embodiments 1-15, wherein the anti-fog material is substantially free of anti-blocking agent, preferably being substantially free of silica.

### Embodiment 17

A process for producing an anti-fog consumer product, the process comprising the steps of (a) forming a precursor composition comprising cellulose acetate and plasticizer to yield a substantially rigid consumer product comprising cellulose acetate and plasticizer and having an outer surface; and (b) saponifying at least a portion of the substantially rigid consumer product to yield the anti-fog consumer product having a degree of substitution at the outer surface of less than 0.75.

### Embodiment 18

The embodiment of any one of embodiments 17 and 19-27, wherein the degree of substitution increases from the outer surface moving inwardly.

### Embodiment 19

The embodiment of any one of embodiments 17 and 20-27, wherein step (b) forms a treated central region being disposed beneath the shaped outer surface and wherein the degree of substitution throughout the treated central region is substantially uniform.

### Embodiment 20

The embodiment of any one of embodiments 17-19 and 21-27, wherein step (b) comprises contacting at least a portion of the substantially rigid consumer product with a caustic solution, preferably being an aqueous hydroxide solution, more preferably being a 5 to 20 wt % potassium hydroxide solution.

### Embodiment 21

The embodiment of embodiments 20, wherein the contacting is conducted for a residence time ranging from 0.5 minutes to 50 minutes, preferably from 2 minutes to 40 minutes.

### Embodiment 22

The embodiment of any one of embodiments 20 and 21, wherein the contacting is conducted at a temperature ranging from 30° C. to 100° C.

### Embodiment 23

The embodiment of any one of embodiments 1-22, and 24-17, wherein the substantially rigid consumer product has a thickness greater than 50 microns.

### Embodiment 24

The embodiment of any one of embodiments 17-23 and 25-27, further comprising the steps of hard coating the anti-fog consumer product to form a coated anti-fog consumer product; and mirror coating the coated anti-fog consumer product to form a mirror coated consumer product.

### Embodiment 25

The embodiment of any one of embodiments 17-24, 26, and 27 further comprising the step of coloring the anti-fog consumer product to yield a colored anti-fog consumer product.

### Embodiment 26

The embodiment of any one of embodiments 17-25 and 27, wherein the coloring comprises dip dying the anti-fog consumer product.

### Embodiment 27

The embodiment of any one of embodiments 17-25 and 27, wherein the precursor composition further comprises a coloring agent, preferably being a dye or pigment, and wherein step (b) yields a colored anti-fog consumer product.

### Examples

### Haze

The haze of anti-fog consumer products prepared via the processes of the present invention was investigated. Sample plaques were prepared by forming a dope comprising cellulose acetate and plasticizer. The dope was cast to form thick (substantially rigid) films. The rigid films had the respective thicknesses shown in Table 1. Some of the films were saponified. These saponified sample films exemplified the inventive anti-fog consumer products. Non-saponified films were used as comparative examples.

Saponified and non-saponified thick films were tested for haze under current ASTM D1003 (2015). The saponified thick films has sufficient rigidity to be utilized in, for example, protective lenses or automotive lamp covers. These thick films had the added advantage of inter alia anti-fog properties (as well as scratch resistance, surface roughness, and chemical resistance), as compared to non-saponified thick films.

The haze testing results are shown in Table 1.

TABLE 1
Haze Results

| | Haze Value | | | | | |
|---|---|---|---|---|---|---|
| | Sam- | Sam- | Sam- | Sam- | Sam- | |
| | ple 1 | ple 2 | ple 3 | ple 4 | ple 5 | Avg. |
| Saponified, thick film, | 0.8 | 0.8 | 0.7 | 0.8 | 0.8 | 0.78 |
| 500 microns | | | | | | |
| Non-saponified, thick | 0.9 | 0.8 | 0.8 | 0.8 | 0.9 | 0.84 |
| film, 500 microns | | | | | | |
| Saponified, thick film, | 1.1 | 1.2 | 1.0 | 1.1 | 1.1 | 1.10 |
| 600 microns | | | | | | |
| Non-saponified, thick | 0.9 | 1.0 | 1.0 | 1.0 | 1.0 | 0.98 |
| film, 600 microns | | | | | | |
| Saponified, thick film, | 1.0 | 1.0 | 1.1 | 0.9 | 1.0 | 1.0 |
| 720 microns | | | | | | |
| Non-saponified, thick | 1.1 | 1.0 | 1.2 | 1.1 | 1.0 | 1.08 |
| film, 720 microns | | | | | | |

Surprisingly, the thick, substantially rigid anti-fog films that were prepared in accordance with the present invention had both significant rigidity and low haze values, as compared to non-saponified thick films. In particular, the haze values of the inventive samples was within 10% of the haze values of the non-saponified comparative examples. In the case of the 600 micron film, the haze value of the saponified thick film was actually less than that of the non-saponified thick film.

### Scratch Resistance

The scratch resistance of anti-fog consumer products prepared via the processes of the present invention was investigated. Sample plaques were prepared by forming a precursor composition comprising cellulose acetate and plasticizer (diethyl phthalate, 32 wt %) and molding the precursor composition to form the plaques. The plaques had a thickness of 1 mm. Some of the plaques were saponified. These saponified sample plaques exemplified the inventive anti-fog consumer products. Non-saponified plaques were used as comparative examples.

Saponified and non-saponified plaques were tested for scratch resistance under current ASTM D4060. A Taber reciprocating abraser was utilized for the abrasion cycles. The inventive samples and the comparative examples were treated for 200, 500, 1000, and 2000 abrasion cycles. Scratch resistance was determined by measuring the panel weight loss caused by the abrasion cycles. The plaques were weighed to nearest 0.1 mg and their weights were recorded. The surfaces of the sample plaques were abraded using a Taber reciprocating abraser under 10N of force for the specified number of abrasion cycles. Loose abradings remaining on the test specimen were removed by light brushing. The abraded plaques were then reweighed and the weight loss was calculated.

The averaged values of the weight loss are shown in Table 2.

TABLE 2
Scratch Resistance Results

| | Weight loss (grams) | | | | |
|---|---|---|---|---|---|
| | | | | | 2000 |
| Sample | 0 cycles | 200 cycles | 500 cycles | 1000 cycles | cycles |
| Saponified | 0 | 0.0016 | 0.004 | 0.0057 | 0.0104 |
| plaques | | | | | |
| Non-saponified | 0 | 0.0001 | 0.001 | 0.0016 | 0.0026 |
| plaques | | | | | |

As shown in Table 2, the saponified plaques surprisingly and unexpectedly showed significantly less weight loss, as compared to plaques that were not saponified.

### Surface Roughness

The surface roughness of anti-fog consumer products prepared via the processes of the present invention were investigated. Inventive sample plaques and comparative sample plaques were prepared as discussed above with regard to scratch resistance.

Saponified and non-saponified plaques were tested using a Mitutoyo Surftest surface roughness gauge, model SJ-210. The averaged roughness values are shown in Table 3.

TABLE 3
Surface Roughness Results

| Sample | Roughness (microns) |
|---|---|
| Saponified | 2.637 |
| Plaques | |
| Non-saponified | 4.345 |
| Plaques | |

As shown in Table 3, the saponified plaques surprisingly and unexpectedly showed significantly lower surface roughness measurements, as compared to plaques that were not saponified.

### Chemical Resistance

The chemical resistance of anti-fog consumer products prepared via the processes of the present invention were investigated. Inventive sample plaques and comparative sample plaques were prepared as discussed above with regard to scratch resistance.

Saponified and non-saponified plaques were tested in accordance with Ford Laboratory Test Method BI 113-08(2008). The following rating scale was used:

| Rating | Description |
|---|---|
| 1 | No visual effect |
| 1.5 | No spotting but slight cloth impression (<10%) |
| 2 | Slight Discoloration/Spotting, (AATCC Proc. 1, min. 4-5), |
| | No color transfer onto cloth (AATCC Proc. 2, min. 5) |
| 3 | Discoloration, (AATCC Proc. 1, min. 4), Cloth impression |
| | (<50%) with slight color transfer (AATCC Proc. 2, min. 4-5) |
| 4 | Cloth impression (>50%) with color transfer (AATCC |
| | Proc. 2, min. 4) |
| 5 | Blistering/complete coating removal (Blistering per |
| | ASTM D714) |

The ratings with respect to insect repellent and sunscreen are shown in Tables 4A and 4B. Cloth impression refers to the impression left by a wiping cloth used to remove sunscreen/insect repellent residue. No cloth impression is desirable. Slight cloth impression increases the chemical resistance rating.

TABLE 4A
Chemical Resistance Results (24 hours at room temperature)

| | Sunscreen | | Insect Repellent | |
|---|---|---|---|---|
| | | Cloth | | Cloth |
| | Rating | Impression | Rating | Impression |
| Saponified | 1 | No | 1.5 | Slight |
| plaques | | | | |
| Non-saponified | 2 | No | 3 | Yes |
| plaques | | | | |

TABLE 4B
Chemical Resistance Results (1 hour at 75° C.)

| | Sunscreen | | Insect Repellent | |
|---|---|---|---|---|
| | | Cloth | | Cloth |
| | Rating | Impression | Rating | Impression |
| Saponified | 1 | No | 1.5 | Slight |
| plaques | | | | |
| Non-saponified | 2 | No | 3 | Yes |
| plaques | | | | |

As shown in Tables 4A and 4B, the saponified plaques surprisingly and unexpectedly showed improvements in chemical resistance to sunscreen and insect repellent (lower ratings). At room temperature, the saponified plaques had higher ratings than the non-saponified plaques. In addition, with respect to insect repellent, the inventive plaques showed no or only slight cloth impression, which is a significant improvement over the non-saponified plaques.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A process for producing an anti-fog consumer product, the process comprising the steps of:
(a) forming a precursor composition comprising cellulose acetate and plasticizer to yield a substantially rigid consumer product having an outer surface; and
(b) saponifying at least a portion of the substantially rigid consumer product to yield the anti-fog consumer product having a degree of substitution at the outer surface of less than 0.75.

2. The process of claim 1, wherein the degree of substitution increases inwardly from the outer surface.

3. The process of claim 1, wherein step (b) forms a treated central region beneath the outer surface and wherein the degree of substitution throughout the treated central region is substantially uniform.

4. The process of claim 1, wherein the substantially rigid consumer product has a thickness greater than 50 microns.

5. The process of claim 1, further comprising the steps of:
hard coating the anti-fog consumer product to form a coated anti-fog consumer product; and
mirror coating the coated anti-fog consumer product to form a mirror coated consumer product.

6. The process of claim 1, further comprising the step of:
coloring the anti-fog consumer product to yield a colored anti-fog consumer product,
wherein the coloring preferably comprises dip dying the anti-fog consumer product.

7. An anti-fog consumer product, comprising cellulose acetate, preferably from 40 wt % to 99 wt % cellulose acetate, and a plasticizer, preferably from 1 wt % to 60 wt % plasticizer, and having an outer surface, the anti-fog consumer product having a degree of substitution at the outer surface of less than 0.75.

8. The anti-fog consumer product of claim 7, wherein the degree of substitution increases inwardly from the outer surface.

9. The anti-fog consumer product of claim 7, further comprising a central region beneath the outer surface;
wherein the degree of substitution throughout the central region is substantially uniform, preferably varying by less than 10%.

10. The anti-fog consumer product of claim 7, wherein the anti-fog consumer product has a fog time greater than 20 seconds, preferably greater than 30 seconds, more preferably greater than 40 seconds.

11. The anti-fog consumer product of claim 7, wherein the anti-fog consumer product has a haze value from 0.1% to 4.0%, preferably from 0.1% to 2.0%, as measured in accordance with ASTM D1003 (2014 or 2015).

12. The anti-fog consumer product of claim 7, wherein the anti-fog consumer product has an impact strength ranging from 20 kj/m² to 60 kj/m², as measured in accordance with ISO 178 (2014 or 2015) and/or a water vapor transmission rate greater than 100.

13. The anti-fog consumer product of claim 7, wherein the anti-fog consumer product has a scratch resistance less than 0.025 grams lost after 2000 abrasion cycles, as measured in accordance with ASTM D4060 (2014 or 2015).

14. The anti-fog consumer product of claim 7, wherein the anti-fog consumer product has a surface roughness less than 5 microns.

15. The anti-fog consumer product of claim 7, wherein the anti-fog consumer product has a chemical resistance rating less than 3, as measured in accordance with Ford Laboratory Test Method BI 113-08 (2014 or 2015).

16. The anti-fog consumer product of claim 7, further comprising a coloring agent, preferably a dye or pigment.

17. The anti-fog consumer product of claim 7, wherein the anti-fog consumer product has opposing outer surfaces and a central region therebetween and the degree of substitution from each outer surface increases inwardly from the respective outer surface.

18. The anti-fog consumer product of claim 17, wherein the degree of substitution at the central region is from 2.0 to 2.7, preferably from 2.0 to 2.6, more preferably from 2.2 to 2.55.

19. The anti-fog consumer product of claim 7, wherein the anti-fog consumer product has opposing planar outer surfaces and a planar central region therebetween and the degree of substitution from each planar outer surface increases inwardly from the respective planar outer surface.

20. The anti-fog consumer product of claim 7, wherein the plasticizer is selected from the group consisting of 1,2,3-triacetoxypropane (triacetin), tributyl citrate, triethyl citrate, triphenyl phosphate, tris(clorisopropyl)phosphate, dimethyl phthalate, bornan-2-one, PEG-DGE, PPG-DGE, tributyl phosphate, and combinations thereof, preferably being diethyl phthalate and/or wherein the anti-fog consumer product is substantially free of anti-blocking agent, and preferably substantially free of silica.
